(19) United States
(12) Patent Application Publication
(10) Pub. No.: US 2019/0344739 A1
(43) Pub. Date: Nov. 14, 2019

(54) METHOD AND PARAMETER MODULE FOR IDENTIFYING THE TYPE AND/OR THE SEVERITY OF A COLLISION OF A VEHICLE WITH A COLLISION OBJECT

(71) Applicant: Robert Bosch GmbH, Stuttgart (DE)

(72) Inventors: Heiko Freienstein, Weil Der Stadt (DE); Jochen Wieland, Renningen (DE); Josef Kolatschek, Weil Der Stadt (DE)

(21) Appl. No.: 16/349,350

(22) PCT Filed: Oct. 4, 2017
(86) PCT No.: PCT/EP2017/075154

§ 371 Date: May 13, 2019

(30) Foreign Application Priority Data
Nov. 28, 2016 (DE) 10 2016 223 541.9

(51) Int. Cl. B60R 21/0132; B60R 21/0134; B60R 21/0136; B60R 21/015

(52) U.S. Cl. CPC B60R 21/0132; B60R 21/0134; B60R 2021/0004; B60R 21/01558; B60R 21/0136

(57) ABSTRACT

A method for identifying the type and/or the severity of a collision of a vehicle of a first mass with a collision object of a second mass in an early phase to trigger safety measures, including: detecting surroundings data of the vehicle; identifying the collision object from the surroundings data; extracting a reference feature, not lying in a direct collision area, of the collision object; repeated successive ascertainment of an instantaneous speed of the vehicle and determining a change of the speed of the vehicle; repeated successive determination of an instantaneous relative speed between the vehicle and the reference feature and determining a change of the speed of the collision object; estimating a mass ratio, effective during the collision, between the mass of the vehicle and the mass of the collision object from the ascertained changes of the speeds of the vehicle and of the collision object.

### BACKGROUND INFORMATION

The present invention relates to a method for identifying the type and/or the severity of a collision of a vehicle, in particular a motor vehicle, with a collision object to trigger suitable safety measures. In particular, the present invention also relates to a parameter module for estimating the absolute mass of a collision object in an early phase of a collision with a vehicle or the ratio of a mass of a vehicle to a mass of a collision object.

Modern motor vehicles are equipped with extensive sensors and monitoring devices with the goal of enhancing the safety for the vehicle occupants. Over the course of developing autonomous vehicles, which participate in traffic without intervention by a driver, increasingly better systems for detecting surroundings data from the surroundings of the vehicle have also been and are being developed. In the present invention, it is assumed that a vehicle is equipped with extensive sensor systems and means for generating surroundings data of its surroundings. In particular, those may be video cameras, radar systems, LIDAR systems, and/or ultrasonic systems.

It is conventional to use such systems to predict non-avoidable or no-longer avoidable collisions preferably early, to estimate their progression and severity, and to trigger safety systems of the vehicle, such as seat belt tensioners, seat adjusters, and/or airbags in a timely fashion in an accident situation. In such systems, it is also common to classify accidents, with respect to their severity and/or progression, into various categories which then lead to different sequences of safety measures.

### SUMMARY

In accordance with the present invention, an example method is provided for identifying the type and/or the severity of a collision of a vehicle with a collision object in an early phase of the collision to trigger suitable safety measures. An example parameter module in accordance with the present invention is also provided.

One parameter in the collision of a vehicle with a collision object, previously difficult to take into consideration, is the mass m₂ of the collision object or the ratio of the mass m₁ of the vehicle to the mass m₂ of the collision object. Knowledge of the masses involved or of the mass ratio m₁/m₂ is of great importance for the preferably accurate prediction of the accident situation, because with this information, accurate predictions about the loads to be expected on the vehicle occupants may be made according to the laws of physics for a/an (plastic) impact. The advantage, which results from an approximate knowledge of the mass of the collision object, at least in the ratio of the mass of the host vehicle, is independent of other accident situations, so that an application is basically advantageous for all types of collisions and impact directions. However, a sequence of events of the accident, in which the front part of the vehicle is affected, thus, for example, an impact directly from the front or at an angle from the front with complete or partial overlap of the front sides of the vehicle and collision object, is of particular importance in the following considerations. The following considerations only apply exactly for a frontal impact with complete overlap; however, they may also be qualitatively applied to other accident situations at different angles with differing overlap. In each case, at least an estimated value for the mass m₂ of the collision object or the mass ratio m₁/m₂ of the vehicle and collision object results, with the aid of which the expected accident situation may be better estimated and categorized, which leads to a more targeted use of safety measures.

In the example method according to the present invention, it is assumed that present systems for scanning the surroundings or for detecting surroundings data of the vehicle recognize and evaluate speed and direction of vehicle and objects toward each other on the basis of already present evaluations systems, so that potential collision objects may also be identified. The detection of surroundings data in step a) of the method may be carried out, for example, via sensors. It is possible that the described method is carried out in a control unit which receives such surroundings data via signal inputs from external sensors (located outside of the module).

In general, it is naturally the goal to prevent collisions through suitable steering and/or braking maneuvers; however, this is not always possible. According to the example method according to the present invention, an object, with which a collision is to be expected, is to be not only identified and the location determined (step b), but also the scanning system for detecting surroundings data is to select at least one reference feature of the collision object (step c) and carry out further observations on the basis of this feature (step d) and other subsequent steps. The recognition, location determination, and the further observation of collision objects in the individual method steps is initially always carried out in a reference system permanently assigned to the motor vehicle. This means that a relative determination of location of the collision object is carried out starting from the motor vehicle, and thus a relative position (relative to the motor vehicle) is ascertained. In steps e) and d), absolute speeds are then calculated in an absolute stationary reference system, in which the motor vehicle also moves. This is carried out by converting the relative observations in the reference system assigned to the vehicle into the absolute reference system, this conversion being able to be carried out with the aid of the speed of the motor vehicle (from step d)).

The reference feature should lie in an area of the collision object which may be well observed before and also during the early phase of the collision, thus, for example, it should not be located down low at the front end of the collision object. In case the collision object is a vehicle, which is the case in most cases, a lower lateral delimitation of a windshield (e.g., the beginning of the A-pillar) is suitable as the reference feature. Many other features suitable for a secure image processing may be stored in a safety system. A scanning system for detecting surroundings data may be concentrated on one or multiple reference features in this way so that the relative speed between the vehicle and collision object may be determined through repeated distance measurement with reference to at least one reference feature. At the same time, the instantaneous speed of the vehicle is known from its sensor system (e.g., measurement of the wheel speed or time integration of measured accelerations). This means that the speed of the collision object may also be established from the measured relative speed and the known speed of the vehicle. As soon as the vehicle and collision object contact each other, the deformation begins on both so that a physical plastic impact may be discussed in the first approximation. The vehicle and collision object thereby become slower, namely as a ratio of their respective masses. By also measuring the relative speed in the early phase of the collision, that means, by repeated measurement of the speed of the vehicle and the relative speed between the vehicle and collision object in known time intervals, the mass ratio between both collision parties may be determined increasingly accurately (the accuracy of the measured results increases with each repetition of the measurements or with increasing time intervals between the measurements). If the mass m₁ of the vehicle is known, then the mass m₂ of the collision object may indeed be absolutely determined from the mass ratio. The expected end speeds of both collision parties at the end of the collision, and thus the severity of the collision from the point of view of the vehicle may already be determined in the early phase of the collision from the initial speeds of the vehicle and collision object (and optionally the collision angle) measured before the collision. This enables suitable safety measures to be triggered in suitable, chronological sequence (or to not be triggered in less severe accidents). In the early phase of the collision, a degree for the type and/or the severity of the collision from the point of view of the vehicle is typically determined based on the ascertained mass ratio, initial speeds measured before the collision, and the numerous additional data of the safety system of the vehicle to trigger appropriate safety measures assigned to this degree at suitable points in time.

In one preferred specific embodiment of the method according to the present invention, the surroundings data are obtained through at least one of the following methods: video monitoring, LIDAR monitoring, radar monitoring, ultrasonic monitoring. Such monitoring systems are used individually or also in combination in modern vehicles including driving assistance systems and are used to enhance the driving safety and for early classification of expected collisions. Video systems, however also the other mentioned systems at increasing rates, are suited for the extraction of reference features and for measuring relative speeds. This may be carried out through image processing methods and/or, for example, through measurements based on the Doppler effect.

In one preferred specific embodiment of the example method according to the present invention, this enables the selection of at least one reference feature on the potential collision object for further observation and for repeated measurements of its instantaneous relative speed toward the vehicle. In the most favorable situation for the described method, in which a potential collision object may already be observed before the collision, quite accurate predictions about the expected accident situation are thus possible.

The instantaneous speed of the vehicle may thus be repeatedly determined before and during the collision from sensors present in the vehicle for rotational speed, speed, acceleration and the like. This enables the absolute speeds of both vehicles to be ascertained and thus other conclusions to be drawn from the relative speed toward the collision object and the speed of the vehicle itself.

In one preferred specific embodiment, the absolute mass m₂ of the collision object is also calculated from the effective mass ratio of the vehicle and collision object at an approximately known mass m₁ of the vehicle, whereby the kinematics of the collision may be calculated under the assumption of a plastic impact essentially according to the conservation of momentum, and may be used for determining the degree for the type and/or the severity of the collision. It is immediately clear that a collision with an object of great mass may have more severe consequences for the occupants of a vehicle than a collision with an object of low mass. For this reason, the timely determination of the mass ratio or of the mass of the collision object in the early phase of the collision before the coordinated triggering of safety measures is an important advantage for the safety of the vehicle occupants.

Due to the fact that the processing of large amounts of surroundings data, as occurs during the scanning of the surroundings of a vehicle, requires substantial computing time, in one preferred specific embodiment of the method according to the present invention, the data processing is concentrated on the processes important for the collision processing in the case that an imminent collision is identified. This means that all uses of the surroundings data are switched off which are not necessary for identifying the type and/or severity of the collision. This provides additional computing capacity for the calculations to be carried out before and during the early phase of the collision, whereby such complex tasks, like the extraction and tracking of reference features and the calculation of the decelerations of both collision parties may be carried out so quickly that the safety measures may be triggered in a timely manner.

The instantaneous speed of the vehicle (step d) and the determination of the instantaneous relative speed between the reference feature and vehicle (step e) are preferably carried out multiple times in identical time intervals during the collision, in each case the changes of the two speeds being determined per time unit so that an increasingly accurate degree for the type and/or the severity of the collision from the point of view of the vehicle results with each measurement. Note should be taken that the entire observation plays out only in a short time frame, mostly less than one second, for which reason the time intervals for the speed measurements should lie in the range of a few milliseconds.

Insofar as it is metrologically possible, it is particularly advantageous if at least two reference features are selected and observed on the collision object, because the measuring accuracy is thereby increased and/or information about additional parameters of the collision and a potential rotation of the collision object may be included in the determination of the degree of the type and/or the severity of the collision. For example, the use of both lower ends of the A-pillars of a vehicle as reference features allow the determination of a collision angle and/or a rotation of the collision parties in relation to each other.

In order to determine a degree for the type and/or the severity of the collision (step g), an initial estimation of an effective mass ratio between the mass of the vehicle and the mass of the collision object is carried out in step f). Subsequently, targeted measures may be triggered in step h) based on the estimated severity of the collision.

Surroundings data of the surroundings of the motor vehicle are used in different ways or by different systems in the vehicle, in the case of a determination of an imminent collision, (all or some) uses of the surroundings data being switched off which are not necessary for identifying the type and/or severity of the collision and the measures resulting therefrom. This is used in particular to provide computing capacity for the calculations (described here) to be carried out before and during the early phase of the collision.

The ascertainment of the instantaneous speed of the vehicle and the determination of the instantaneous relative speed between a reference feature and vehicle are preferably carried out multiple times, in particular at identical time intervals during the collision, in each case the change of the two speeds being also determined per time unit. Thus, an increasingly accurate degree results for the type and/or the severity of the collision from the point of view of the vehicle.

In step c), at least two reference features on a collision object are preferably extracted and observed in the subsequent steps. Thus, the measuring accuracy is increased and/or it is possible to incorporate information about additional parameters of the collision and a potential rotation of the collision object into the determination of the degree of the type and/or the severity of the collision. A higher measuring accuracy may be achieved, for example, by considering two or more reference features for the adjustment. A rotation may be recognized, for example, on the basis of differences of the speeds of two reference features on a collision object.

An example control unit according to the present invention is also provided. It is used for estimating the absolute mass m₂ of a collision object in an early phase of a collision with a vehicle or to estimate the ratio m₁/m₂ of a mass m₁ of a vehicle in relation to a mass m₂ of a collision object in an early phase of the collision, the module being assigned to a system in the vehicle for triggering suitable safety measures during a collision, the module additionally having inputs for measured values of at least one first measuring device for repeated determination of the relative speed between the vehicle and the collision object before and during the early phase of the collision and having at least one second measuring device for repeated determination of the absolute speed of the vehicle, and the control unit being designed for estimating the mass m₂ of the collision object or the mass ratio m₁/m₂ of the vehicle and collision object from the change of the absolute speed of the vehicle and the relative speed toward the collision object in the early phase of the collision based on the conservation of momentum. The particular advantages shown for the described method and specific embodiment features are applicable and transferable to the described control unit.

Such a control unit is suitable as part of a safety system of a motor vehicle and contributes important information about the classification of a collision so that suitable safety measures may be triggered. The second mass m₂ or the ratio m₁/m₂ of the masses of the motor vehicle and the collision object, ascertained by the parameter module, are essential parameters for the expected sequence of a collision, so that a more accurate prediction may be made with the help of the parameter module about expected loads on the occupants of the motor vehicle and about suitable safety measures.

The method in accordance with the present invention are described below in greater detail by way of the figures.

### BRIEF DESCRIPTION OF THE DRAWINGS

FIG. 1 schematically shows a situation shortly before a collision of a vehicle with a collision object.

FIG. 2 shows a flow chart of an example of a method according to the present invention.

### DETAILED DESCRIPTION OF EXAMPLE EMBODIMENTS

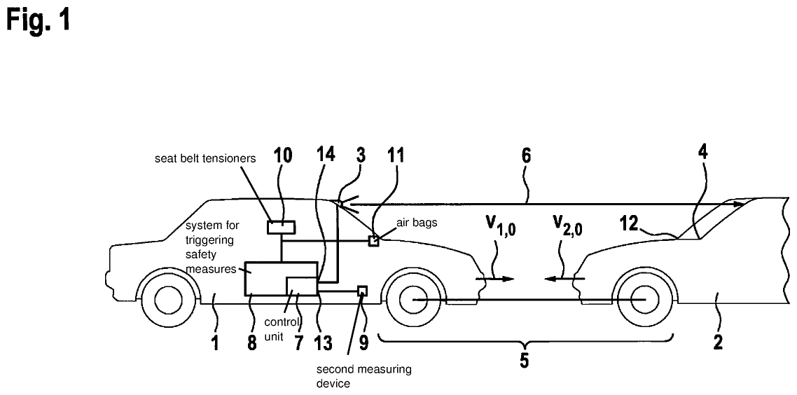

FIG. 1 shows in a schematic depiction a constellation shortly before the impact of a motor vehicle 1 with a collision object 2. Motor vehicle 1 has initial speed V_{1,0} and mass m₁. The collision object, in the present case likewise depicted as a motor vehicle by way of example, has initial speed V_{2,0} and mass m₂. Before the collision, the two collision parties have a certain distance and a spatial orientation to each other. The area directly affected by a collision (which is thereby deformed) is subsequently designated as collision area 5. Vehicle 1 has at least one first measuring device 3 for detecting surroundings data of the surroundings of vehicle 1. This is thereby typically a camera, an ultrasonic system or laser system, or a radar device. A laser scanning system is preferably used for detecting surroundings data because this may also provide, simultaneously with data about the direction of an object, data about the relative movement between vehicle 1 and collision object 2, for example, by measuring the Doppler effect.

Under favorable conditions, first measuring device 3 already provides extensive data about a potential collision object 2 already before a collision. Within the scope of the present observations, it is assumed that driving assistance systems or systems for autonomous driving, present in vehicle 1, identify potential collision objects 2 at an early state and may provide a collision prediction. If a potential collision object 2 is identified, then at least one first reference feature 4 is identified on collision object 2 with the aid of first measuring device 3 and extracted for a closer observation. Since this first reference feature 4 is to be further observed also during the collision, it should not lie in a direct collision area 5, which deforms first during a collision. A lower corner of a lateral delimitation of a windshield, a so-called A-pillar of a motor vehicle, offers a suitable reference feature. For increased accuracy of the additional measurements, a second reference feature 12, and additional reference features may also be involved, depending on the capability of the data processing in vehicle 1. In any case, the relative distance 6 between first measuring device 3 and first reference feature 4 (and naturally additional reference features) is measured quite precisely before and during a collision. This is carried out before and primarily during the collision in preferably identical time intervals. A second measuring device 9 in vehicle 1 enables it to measure the absolute speed of this vehicle at any time. A plurality of different systems may be used for this purpose. As a result, speed data V_{1,0}, V_{1,1}, V_{1,2} . . . V_{1,n} at points in time 0, 1, 2 . . . n are available at an input 13. Likewise, information about distance 6 between first measuring device 3 and first reference feature 4 is available at control unit 7 at an input 14 for surroundings data. Data about relative speed V_{r,0}, V_{r,1}, V_{r,2} . . . V_{R,n} is often also already available or may be calculated from the chronological sequence of these data.

A main goal of the described system is to support the safety system of vehicle 1 through additional information in the estimation of the severity of a collision, so that safety measures may be triggered in a timely manner and to a suitable extent. For estimating a collision, it is not only important to be able to estimate the geometric data of a collision sequence, for example, impact angle, impact speed, and impact point in time, but also mass m₂ of collision object 2 or the ratio of mass m₁ of vehicle 1 to mass m₂ of collision object 2 is also of great significance. If one essentially assumes a plastic impact, then the collision parties deform in collision area 5 and both become slower in the process. Expressed simply, the mass ratio may be calculated from the difference of the speed decelerations (thus the negative acceleration of both collision parties), under the assumption, that mass m₁ of vehicle 1 being known, the absolute masses of both vehicles may be calculated. However, for the progression of the collision, basically only the ratio of the two masses is important. As is subsequently explained in greater detail by way of the corresponding formulas, one may therefore calculate, from the speed deceleration of both collision parties 1, 2, in the early phase of a collision, typically in the first 10 through 100 milliseconds, which end speed V_{end} vehicle 1 and collision object 2 will have after the collision (both ultimately have the same speed in a plastic impact) from which the load to be expected for the occupants of vehicle 1 may be better estimated. Control unit 7 therefore contributes data about the mass ratio of the collision parties to system 8 for triggering the safety measures, whereby the sequence and consequences of the collision may be more accurately estimated and safety elements triggered in a suitable way. In particular, seat belt tensioners 10 and/or air bags 11 may be triggered, for example.

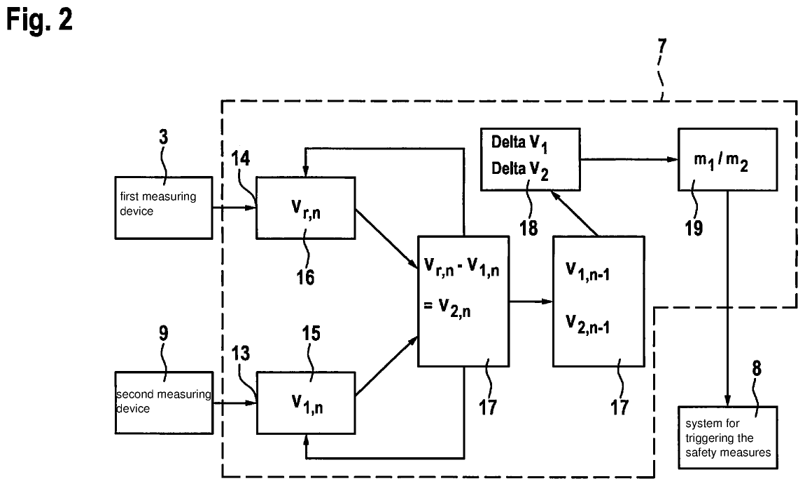

FIG. 2 illustrates the progression of the method in accordance with the present invention in control unit 7. Surroundings data are forwarded from first measuring device 3 to input 14 for surroundings data, also including data for relative speed V_{r,n} between vehicle 1 and collision object 2 at points in time 0, 1, 2 . . . n closely following each other. V_{r,0} is thereby the last relative speed measured before the collision, while the following speeds are measured in the early phase of the collision. Speed data are forwarded from second measuring device 9 of vehicle 1 to input 13 for speed data. These data are available for a speed determination 15, from which speeds V_{1,0}, V_{1,1}, V_{1,2} . . . V_{1,n} at points in time 0, 1, 2, . . . n are selected or calculated. The data from a relative speed determination 16 and speed determination 15 are forwarded to an absolute speed determination 17, absolute speed V₂ resulting from the difference of relative speed Vᵣ and speed V₁. Speed V_{1,0}, V_{1,1} . . . V_{1,n} of vehicle 1 and speed V_{2,0}, V_{2,1} . . . V₂,n of collision object 2 are available in absolute speed determination 17 for each point in time t=0, 1, 2 . . . n. In an acceleration determination 18, therefore, the speed differences may be determined at every point in time t=1, 2, . . . n for the preceding point in time t=0, 1, 2 . . . n−1. As needed, speed differences may be determined over longer time frames for increasing the measuring accuracy, or the individually calculated values may be analyzed at different points in time. In total, a negative acceleration results in acceleration determination 18 for both collision parties, so that, assuming the physical laws of a plastic (or at least partially plastic) impact, ratio m₁/m₂ of the participating masses may be estimated in a mass (ratio) determination 19. This ratio is forwarded to system 8 to trigger safety measures, whereby the mass ratio or, if mass m₁ of vehicle 1 is known, both absolute masses of the collision partners may be taken into account in the considerations regarding severity S of a collision. The described calculations are carried out in a simplified depiction according to the following formulas:

V_{2,n}=V_{r,n}−V_{1,n} at point in time n=0,1,2 . . . n

Delta V_{1,n}=V_{1,n}−V_{1,n-1} at point in time n=1,2 . . . n

Delta V_{2,n}=V_{2,n}−V_{2,n-1} at point in time n=1,2 . . . n

m₁*V_{1,0}+m₂*V_{2,0}=(m₁+m₂)*V_{end}

S=V_{1,0}−V_{end}

S=m₂/(m₁+m₂)*(V_{1,0}−V_{2,0})

where
V_{end}=end speed of both collision parties after the collision
Delta=speed deceleration
S=degree of the severity of a collision

The method in accordance with the present invention enables a system for triggering safety measures in a vehicle 1 with a collision object 2 to obtain data in the early phase of a collision, which enable an estimation of the mass ratio between vehicle 1 and collision object 2, which enables a more accurate, early estimation of the consequences of the collision for the occupants of vehicle 1, whereby a better chronological adjustment and coordination of safety measures, in particular the triggering of seat adjusters, seat belt tensioners, and/or airbags, is facilitated.

1-10. (canceled)

11. A method for identifying the type and/or the severity of a collision of a vehicle of a first mass with a collision object of a second mass in an early phase of the collision to trigger safety measures, the method comprising:
a) detecting surroundings data of surroundings of the vehicle;
b) identifying the collision object from the surroundings data;
c) extracting at least one reference feature, not lying in a direct collision area, of the collision object for further observation of a relative speed between the reference feature of the collision object and the vehicle;
d) repeatedly successively ascertaining an instantaneous speed of the vehicle and determining a change of the speed of the vehicle;
e) repeatedly successively determining an instantaneous relative speed between the vehicle and the reference feature and determining a change of the speed of the collision object; and
f) estimating a mass ratio, effective during the collision, between the mass of the vehicle and the mass of the collision object from the ascertained changes of the speed of the vehicle and the ascertained changes of the speeds of the collision object.

12. The method as recited in claim 11, wherein subsequent to step f), the following steps are carried out:
g) determining a degree for the type and/or the severity of the collision from a point of view of the vehicle based on the ascertained mass ratio, an initial speed of the vehicle measured before the collision, and an initial relative speed between the vehicle and the collision object;
h) triggering at least one safety measure suitable for the type or severity of the collision at a point in time based on the type or severity of the collision.

13. The method as recited in claim 11, wherein the surroundings data of the surroundings are obtained by at least one of the following methods: video monitoring, and/or LIDAR monitoring, and/or radar monitoring, and/or ultrasonic monitoring.

14. The method as recited in claim 11, wherein for a potential collision object, at least one reference feature, identifiable from the surroundings data, is selected for further observation and its instantaneous relative speed with respect to the vehicle is repeatedly measured.

15. The method as recited in claim 11, wherein the instantaneous speed of the vehicle is repeatedly determined before and during a collision from sensors present in the vehicle for rotational speed, and/or speed, and/or accelerations.

16. The method as recited in claim 11, wherein an absolute mass of the collision object is also calculated from the mass ratio in the case of an approximately known mass of the vehicle, whereby kinematics of the collision are calculated, under the assumption of a plastic impact according to conservation of momentum, and is used for determining a degree of the type and/or the severity of the collision.

17. The method as recited in claim 11, wherein surroundings data of the surroundings are used in different ways or by different systems in the vehicle, in the case of a determination of an imminent collision, uses of the surroundings data being switched off which are not necessary for identifying the type and/or the severity of the collision or are not necessary for measures following from the collision.

18. The method as recited in claim 11, wherein the ascertainment of the instantaneous speed of the vehicle and the determination of the instantaneous relative speed between the reference feature and the vehicle are carried out repeatedly in identical time intervals during the collision, the change of the speed of the vehicle and the change of the speed of the collision object also being determined per time unit.

19. The method as recited in claim 11, wherein, in step c), two reference features on the collision object are extracted and observed in the subsequent steps.

20. A control unit for estimating the absolute mass of a collision object in an early phase of a collision with a vehicle, or of a ratio of a mass of a vehicle in relation to a mass of a collision object in an early phase of a collision, the control unit being assigned to a system in the vehicle for triggering suitable safety measures on safety elements during a collision, the control unit having inputs for measured values from at least one first measuring device for repeated determination of a relative speed between the vehicle and the collision object before and during the early phase of the collision, and from at least one second measuring device for repeated determination of an absolute speed of the vehicle, and the control unit being configured to estimate the mass of the collision object or the mass ratio of the vehicle and the collision object from a change of the absolute speed of the vehicle and a change of the relative speed toward the collision object in the early phase of the collision on the basis of conservation of momentum.
